(19) United States
(12) Patent Application Publication
(10) Pub. No.: US 2022/0251280 A1
(43) Pub. Date: Aug. 11, 2022

(54) PROCESS OF PREPARING ALLOPHANATE- AND/OR THIOALLOPHANATE GROUP-CONTAINING COMPOUNDS

(71) Applicant: COVESTRO INTELLECTUAL PROPERTY GMBH & CO. KG, Leverkusen (DE)

(72) Inventors: Hans-Josef Laas, Odenthal (DE); Florian Stempfle, Köln (DE); Kai Laemmerhold, Odenthal (DE); Saskia Beuck, Leverkusen (DE); Raul Pires, Köln (DE); Christoph Guertler, Köln (DE); Nusret Yuva, Burscheid (DE); Ralph-Georg Born, Remscheid (DE); Daniel Thiel, Leverkusen (DE); Sureshbabu Guduguntla, Turnhout (BE); Walter Leitner, Aachen (DE)

(21) Appl. No.: 17/624,763

(22) PCT Filed: Jul. 6, 2020
(86) PCT No.: PCT/EP2020/068926

§ 371 Date: Jan. 4, 2022

(30) Foreign Application Priority Data
Jul. 11, 2019 (EP) 19185846.3

(51) Int. Cl. C08G 18/02; C08G 18/20; C08L 75/04; C09D 175/04

(52) U.S. Cl. CPC C08G 18/027; C09D 175/04; C08L 75/04; C08G 18/2027

(57) ABSTRACT

The invention relates to a process of preparing allophanate- and/or thioallophanate group-containing compounds comprising the following steps: reacting A) at least one component having at least one uretdione group with B) at least one component having at least one hydroxyl and/or thiol group, in the presence C) of at least one catalyst, containing a structural element of the general formulae (I) and/or (II), wherein R¹, R², R³, R⁴, R⁵ and R⁶ independently of each other represent the same or different radicals meaning saturated or unsaturated, linear or branched, aliphatic, cycloaliphatic, araliphatic or aromatic organic radicals with 1 to 18 carbon atoms that are substituted or unsubstituted and/or have heteroatoms in the chain, the radicals being capable of forming, even when combined with each other and optionally together with an additional heteroatom, rings with 3 to 8 carbon atoms that can optionally be further substituted, wherein R³, R⁴, R⁵ and R⁶ independently of each other also can represent hydrogen, and R⁷ represents hydrogen or a carboxylate anion (COO⁻), the at least one component A) having at least one uretdione group being polyaddition compounds A2) that can be obtained by reacting isocyanate-functional uretdione groups A1) with alcohols and/or amines that have a free isocyanate group content of less than 5 wt. % in their solvent-free form.

The present invention relates to a process for producing allophanate- and/or thioallophanate-containing compounds, to uretdione-containing compositions and to the use of these compositions for producing polyurethane plastics or coatings. The invention further relates to coating formulations containing the compositions and to substrates coated with the coating formulation.

Uretdione-containing polyaddition products are known as crosslinker components for thermally crosslinkable polyurethane (PUR) coating and adhesive compositions. In these products the crosslinking principle is the thermal ring opening of the uretdione groups to afford isocyanate groups and the reaction thereof with a hydroxy-functional or amino-functional binder.

Uretdione-containing crosslinkers are nowadays used in practice almost exclusively for producing donor-free polyurethane (PUR) powder coatings (for example DE-A 2 312 391, DE-A 2 420 475, EP-A 0 045 994, EP-A 0 045 996, EP-A 0 045 998, EP-A 0 639 598 or EP-A 0 669 353). The use of uretdione-containing polyurethanes as crosslinker components for solvent-containing or aqueous one-component systems has likewise already been described (for example WO 99/11690, WO 2014/053269), inter alia due to the comparatively low reactivity of the internally blocked isocyanate groups present in the form of uretdione structures which in combination with polyols generally require baking temperatures of at least 160° C., but such systems have not hitherto succeeded in establishing themselves in the market.

There has been no lack of attempts to lower the curing temperatures of uretdione-containing coating systems through use of suitable catalysts. Various compounds have already been proposed for this purpose, for example the organometallic catalysts known from polyurethane chemistry, such as tin(II) acetate, tin(II) octoate, tin(II) ethylcaproate, tin(II) laurate, dibutyltin diacetate, dibutyltin dilaurate, dibutyltin maleate (for example EP-A 0 045 994, EP-A 0 045 998, EP-A 0 601 079, WO 91/07452 or DE-A 2 420 475), iron (III) chloride, zinc chloride, zinc 2-ethylcaproate and molybdenum glycolate, tertiary amines such as triethylamine, pyridine, methylpyridine, benzyldimethylamine, N,N-endoethylenepiperazine, N-methylpiperidine, pentamethyldiethylenetriamine, N,N-dimethylaminocyclohexane and N,N′-dimethylpiperazine (for example EP-A 0 639 598) or N,N,N′-trisubstituted amidines, in particular bicyclic amidines, such as 1,5-diazabicyclo[4.3.0]non-5-ene (DBN) and 1,8-diazabicyclo[5.4.0]undec-7-ene (DBU) (for example EP-A 0 803 524 or WO 2011/115669).

Of these catalysts the recited bicyclic amidines allow the lowest baking temperatures. However, they also result in a degree of yellowing that is unacceptable for many fields of application.

EP-A 1 137 689 teaches that Lewis acid catalysts such as for example the abovementioned tin or zinc compounds are inhibited by acidic groups such as for example carboxyl groups. They can therefore only develop their full catalytic activity in a uretdione system when the employed hydroxy-functional binder is free from carboxyl groups. This is achievable for example by simultaneous addition of a sufficient amount of a carboxyl-reactive agent, for example a carbodiimide or an epoxide.

In the absence of carboxyl groups or with co-use of a carboxyl-reactive compound suitable catalysts also include quaternary ammonium hydroxides and ammonium fluorides (for example EP-A 1 334 987), ammonium carboxylates (for example EP-A 1 475 399, EP-A 1 522 547), phosphonium hydroxides, alkoxides or carboxylates (for example WO 2005/085315) or metal hydroxides and alkoxides (for example EP-A 1 475 400) which allow the curing temperature of uretdione systems to be markedly reduced.

A uretdione structure can in principle react in two ways during curing: complete cleavage into two isocyanate groups which further form urethane groups with two hydroxyl groups of the polyol, or only one-sided ring opening with only one hydroxyl group of the polyol to form an allophanate structure. In catalyzed uretdione systems both reactions generally occur simultaneously and the preference between the two reaction products is shifted with the curing conditions, in particular temperature. The trimerization of isocyanate groups to afford isocyanurate structures is often also at the same time observable to varying extents.

This not unambiguously defined curing behavior of the uretdiones in practice impedes establishment of optimal stoichiometry between the uretdione crosslinker and the polyol and contributes to the low prevalence of low temperature crosslinking uretdione systems.

The present invention accordingly has for its object to provide novel catalysts for reducing the curing temperature of uretdione systems which result in the most complete possible reaction of the uretdione structures and thus provide a fixed ratio of the reaction products independently of the curing temperature.

This object is achieved by providing the catalyzed uretdione-containing compositions more particularly described hereinbelow.

The present invention is based on the surprising observation that special salts having an imidazolium or dihydroimidazolium structure are highly effective catalysts for the reaction of uretdiones with alcohols and/or thiols, wherein independently of the selected temperature exclusively allophanate, thioallophanate and optionally isocyanurate structures are formed in a fixed ratio.

Such catalysts are known and have in the past also been employed in polyurethane chemistry. WO 2011/061314 also describes imidazolium salts as a possible alternative to toxicologically questionable tin catalysts, for example dibutyltin dilaurate (DBTL), for the reaction of isocyanates with polyols in polyurethane synthesis. While this publication does also provide a blanket mention within a long list of possible starting polyisocyanates for urethanization of those having a uretdione structure, the publication as a whole provides no indication of the particular suitability of imidazolium and dihydroimidazolium compounds as catalysts for selective uretdione cleavage to form allophanate or thioallophanate structures.

Disclosed is a process for producing allophanate and/or thioallophanate-containing compounds comprising reacting
A) at least one component comprising at least one uretdione group with
B) at least one component comprising at least one hydroxyl and/or thiol group in the presence of
C) at least one catalyst containing a structural element of general formulae (I) and/or (II)

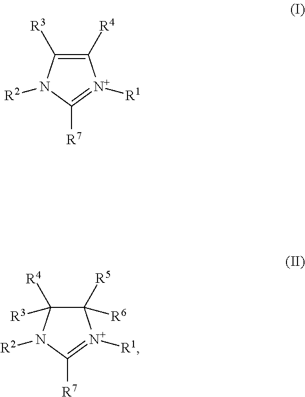

in which
R¹, R², R³, R⁴, R⁵ and R⁶ independently of one another stand for identical or different radicals which represent saturated or unsaturated, linear or branched, aliphatic, cycloaliphatic, araliphatic or aromatic organic radicals having 1 to 18 carbon atoms which are substituted or unsubstituted and/or have heteroatoms in the chain, wherein the radicals may also in combination with one another and optionally with a further heteroatom form rings having 3 to 8 carbon atoms which may optionally be further substituted, wherein
R³, R⁴, R⁵ and R⁶ may independently of one another also represent hydrogen and
R⁷ represents hydrogen or a carboxylate anion (COO⁻).

The present invention provides a process for producing allophanate and/or thioallophanate-containing compounds comprising reacting
A) at least one component comprising at least one uretdione group with
B) at least one component comprising at least one hydroxyl and/or thiol group in the presence of
C) at least one catalyst containing a structural element of general formulae (I) and/or (II)

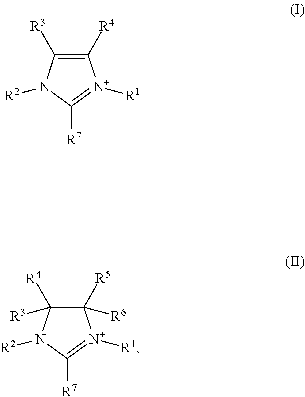

in which
R¹, R², R³, R⁴, R⁵ and R⁶ independently of one another stand for identical or different radicals which represent saturated or unsaturated, linear or branched, aliphatic, cycloaliphatic, araliphatic or aromatic organic radicals having 1 to 18 carbon atoms which are substituted or unsubstituted and/or have heteroatoms in the chain, wherein the radicals may also in combination with one another and optionally with a further heteroatom form rings having 3 to 8 carbon atoms which may optionally be further substituted, wherein
R³, R⁴, R⁵ and R⁶ may independently of one another also represent hydrogen and
R⁷ represents hydrogen or a carboxylate anion (COO⁻), wherein the at least one component A) comprising at least one uretdione group is selected from polyaddition compounds A2) obtainable by reaction of isocyanate-functional uretdione-containing compounds A1) with alcohols and/or amines which in solvent-free form have a content of free isocyanate groups of less than 5% by weight.

According to the invention, the references to “comprising”, “containing”, etc., preferably denote “substantially consisting of” and very particularly preferably denote “consisting of”. The further embodiments identified in the claims and in the description can be combined arbitrarily, provided the context does not clearly indicate that the opposite is the case.

The uretdione-containing component A) is selected from any desired, optionally isocyanate-functional uretdione-containing compounds A1) such as are obtainable by methods known per se, for example by oligomerization of monomeric isocyanates, and/or polyaddition compounds A2) obtainable by reaction of isocyanate-functional uretdione-containing compounds A1) with alcohols and/or amines.

In the process according to the invention the at least one component A) comprising at least one uretdione group is a polyaddition compound A2) obtainable by reaction of isocyanate-functional uretdione-containing compounds A1) with alcohols and/or amines.

Suitable isocyanates for producing the uretdione-containing compounds A1) are any mono-, di-, and triisocyanates having aliphatically, cycloaliphatically, araliphatically and/or aromatically bonded isocyanate groups obtainable in various ways, for example by phosgenation in the liquid or gas phase or by a phosgene-free route, for example by thermal urethane cleavage.

Preferred monoisocyanates are those in the molecular weight range 99 to 300, for example n-butyl isocyanate, n-amyl isocyanate, n-hexyl isocyanate, n-heptyl isocyanate, n-octyl isocyanate, undecyl isocyanate, dodecyl isocyanate, tetradecyl isocyanate, cetyl isocyanate, stearyl isocyanate, cyclopentyl isocyanate, cyclohexyl isocyanate, 3- and 4-methylcyclohexyl isocyanate, benzyl isocyanate, phenyl isocyanate or naphthyl isocyanate.

Preferred diisocyanates are those in the molecular weight range 140 to 400, for example 1,4-diisocyanatobutane, 1,5-diisocyanatopentane (pentamethylene diisocyanate, PDI), 1,6-diisocyanatohexane (hexamethylene diisocyanate, HDI), 2-methyl-1,5-diisocyanatopentane, 1,5-diisocyanato-2,2-dimethylpentane, 2,2,4- and 2,4,4-trimethyl-1,6-diisocyanatohexane, 1,10-diisocyanatodecane, 1,3- and 1,4-diisocyanatocyclohexane, 1,3- and 1,4-bis(isocyanatomethyl)cyclohexane, 1,3-diisocyanato-2(4)-methylcyclohexane, 1-isocyanato-3,3,5-trimethyl-5-isocyanatomethylcyclohexane (isophorone diisocyanate, IPDI), 2,4′- and 4,4′-diisocyanatodicyclohexylmethane (H₁₂-MDI), 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bicyclohexyl, 4,4′-diisocyanato-3,3′-dimethyl-1,1′-bicyclohexyl, 4,4′-diisocyanato-2,2′,5,5′-tetramethyl-1,1′-bicyclohexyl, 1,8-diisocyanato-p-methane, 1,3-diisocyanatoadamantane, 1,3-dimethyl-5,7-diisocyanatoadamantane, 1-isocyanato-1-methyl-4(3)-isocyanatomethylcyclohexane, bis(isocyanatomethyl)norbornane (NBDI), 1,3- and 1,4-bis(isocyanatomethyl)benzene (xylylene diisocyanate, XDI), 1,3- and 1,4-bis(2-isocyanatopropan-2-yl) benzene (tetramethylxylylene diisocyanate, TMXDI), 1,3-bis(isocyanatomethyl)-4-methylbenzene, 1,3-bis(isocyanatomethyl)-4-ethylbenzene, 1,3-bis(isocyanatomethyl)-5-methylbenzene, 1,3-bis(isocyanatomethyl)-4,5-dimethylbenzene, 1,4-bis(isocyanatomethyl)-2,5-dimethylbenzene, 1,4-bis(isocyanatomethyl)-2,3,5,6-tetramethylbenzene, 1,3-bis(isocyanatomethyl)-5-tert-butylbenzene, 1,3-bis(isocyanatomethyl)-4-chlorobenzene, 1,3-bis(isocyanatomethyl)-4,5-dichlorobenzene, 1,3-bis(isocyanatomethyl)-2,4,5,6-tetrachlorobenzene, 1,4-bis(isocyanatomethyl)-2,3,5,6-tetrachlorobenzene, 1,4-bis(isocyanatomethyl)-2,3,5,6-tetrabromobenzene, 1,4-bis(2-isocyanatoethyl)benzene and 1,4-bis(isocyanatomethyl)naphthalene, 1,2-, 1,3-, and 1,4-diisocyanatobenzene (phenylene diisocyanate), 2,4- and 2,6-diisocyanatotoluene (tolylene diisocyanate, TDI), 2,3,5,6-tetramethyl-1,4-diisocyanatobenzene, the isomeric diethylphenylene diisocyanates, diisopropylphenylene diisocyanates, diisododecylphenylene diisocyanates, and biphenyl diisocyanates, 3,3′-dimethoxybiphenyl 4,4′-diisocyanate, 2,2′-, 2,4′- and 4,4′-diisocyanatodiphenylmethane (MDI), 3,3′-dimethyldiphenylmethane 4,4′-diisocyanate, 4,4′-diisocyanatodiphenylethane, 1,5-diisocyanatonaphthalene (naphthylene diisocyanate, NDI), diphenyl ether diisocyanate, ethylene glycol diphenyl ether diisocyanate, diethylene glycol diphenyl ether diisocyanate, 1,3-propylene glycol diphenyl ether diisocyanate, benzophenone diisocyanate, triisocyanatobenzene, 2,4,6-triisocyanatotoluene, trimethylbenzene triisocyanate, diphenylmethane 2,4,4′-triisocyanate, 3-methyldiphenylmethane-4,6,4′-triisocyanate, the isomeric naphthalene triisocyanates and methylnaphthalene diisocyanates, triphenylmethane triisocyanate or 2,4-diisocyanato-1-[(5-isocyanato-2-methylphenyl)methyl]benzene.

Further diisocyanates that are likewise suitable may additionally be found for example in Justus Liebigs Annalen der Chemie, volume 562 (1949) pp. 75-136.

An example of a particularly suitable triisocyanate is 4-isocyanatomethyloctane 1,8-diisocyanate (triisocyanatononane; TIN).

Also employable for producing the uretdione-comprising compounds A1) are mixtures of at least two such mono-, di-, and/or triisocyanates.

Preferably employed for producing the uretdione-comprising compounds A1) are monomeric diisocyanates.

Particular preference is given to using PDI, HDI, IPDI, XDI, NBDI and/or H₁₂-MDI.

The production of the uretdione-containing compounds A1) may be carried out by various methods which are generally based on the customary processes known from the literature for oligomerization of simple diisocyanates, as described for example in J. Prakt. Chem. 336 (1994) 185-200, DE-A 16 70 666, DE-A 19 54 093, DE-A 24 14 413, DE-A 24 52 532, DE-A 26 41 380, DE-A 37 00 209, DE-A 39 00 053, DE-A 39 28 503, EP-A 336 205, EP-A 339 396 and EP-A 798 299.

The uretdione-containing compounds A1) may in the case of exclusive use or partial co-use of monoisocyanates be free from isocyanate groups. However, the production thereof preferably also employs at least di- and/or triisocyanates in amounts such that it affords uretdione-containing compounds A1) having an average NCO functionality of at least 1.6, preferably of 1.8 to 3.5, particularly preferably of 1.9 to 3.2, very particularly preferably of 2.0 to 2.7.

At average NCO functionalities of >2.0 these compounds A1) containing isocyanate-functional uretdione groups contain not only linear difunctional uretdione structures but also further, at least trifunctional, polyisocyanate molecules. These higher functional constituents of the compounds A1) are in particular the known reaction products of diisocyanates with an isocyanurate, allophanate, biuret, urethane and/or iminooxadiazinedione structure.

The uretdione-containing compounds A1) are generally freed of unreacted excess monomer immediately after their above-described production by modification of simple monomeric mono-, di- and/or triisocyanates by known methods, for example by thin-film distillation or extraction. Said compounds therefore generally have residual contents of monomeric diisocyanates of less than 5% by weight, preferably less than 2% by weight, particularly preferably less than 1% by weight.

Irrespective of the chosen production process, the uretdione-containing compounds A1) generally have a content of uretdione structures (calculated as C₂N₂O₂, molecular weight=84) of 10% to 25% by weight, preferably of 12% to 23% by weight, particularly preferably of 14% to 20% by weight.

In a further preferred embodiment the component A1) is selected from uretdione-containing compounds based on PDI, HDI, IPDI, XDI, NBDI and/or H₁₂-MDI which preferably have an average NCO functionality of at least 1.6 and particularly preferably have a content of uretdione structures (calculated as C₂N₂O₂, molecular weight=84) of 10% to 25% by weight.

Likewise suitable as uretdione-containing component A) of the compositions according to the invention are polyaddition compounds A2), such as are obtainable by reaction of at least a portion of the free isocyanate groups of the above-described isocyanate-functional uretdione-containing compounds A1) with alcohols and/or amines.

Suitable alcohols for producing the polyaddition compounds A2) are for example simple aliphatic or cycloaliphatic monoalcohols, such as methanol, ethanol, n-propanol, isopropanol, n-butanol, isobutanol, sec-butanol, the isomeric pentanols, hexanols, octanols, and nonanols, n-decanol, n-dodecanol, n-tetradecanol, n-hexadecanol, n-octadecanol, cyclohexanol, the isomeric methylcyclohexanols and hydroxymethylcyclohexane, ether alcohols such as 2-methoxyethanol, 2-ethoxyethanol, 2-propoxyethanol, 2-butoxyethanol, diethylene glycol monomethyl ether, diethylene glycol monoethyl ether, diethylene glycol monobutyl ether, 3-methoxy-1-butanol and glycerol 1,3-diethyl ether, ester alcohols, such as hydroxyethyl acetate, butyl glycolate, ethyl lactate, glycerol diacetate or those that can be obtained by reacting the recited monoalcohols with lactones, or ether alcohols such as can be obtained by reacting the recited monoalcohols with alkylene oxides, in particular ethylene oxide and/or propylene oxide.

Alcohols suitable for producing the polyaddition compounds A2) likewise include any at least difunctional polyols in the molecular weight range 62 to 22 000, preferably those having an average functionality of 2 to 6 and a number average molecular weight of 62 to 18 000, particularly preferably an average functionality of 2 to 4 and a number average molecular weight of 90 to 12 000.

Suitable polyols for producing the polyaddition compounds A2) are for example simple polyhydric alcohols having 2 to 14, preferably 4 to 10, carbon atoms, for example ethane-1,2-diol, propane-1,2-diol and -1,3-diol, the isomeric butanediols, pentanediols, hexanediols, heptanediols and octanediols, decane-1,10-diol, dodecane-1,12-diol, cyclohexane-1,2-diol and -1,4-diol, cyclohexane-1,4-dimethanol, 1,4-bis(2-hydroxyethoxy)benzene, 2,2-bis(4-hydroxyphenyl)propane (bisphenol A), 2,2-bis(4-hydroxycyclohexyl)propane (perhydrobisphenol), propane-1,2,3-triol, butane-1,2,4-triol, 1,1,1-trimethylolethane, hexane-1,2,6-triol, 1,1,1-trimethylolpropane (TMP), bis(2-hydroxyethyl)hydroquinone, 1,2,4- and 1,3,5-trihydroxycyclohexane, 1,3,5-tris(2-hydroxyethyl)isocyanurate, 3(4),8(9)-bis(hydrownethyl)-tricyclo-[5.2.1.0^{2,6}]decane, di-trimethylolpropane, 2,2-bis(hydroxymethyl)propane-1,3-diol (pentaerythritol), 2,2,6,6-tetrakis(hydroxymethyl)-4-oxaheptane-1,7-diol (dipentaerythritol), mannitol or sorbitol, low-molecular-weight ether alcohols, for example diethylene glycol, triethylene glycol, tetraethylene glycol, dipropylene glycol or dibutylene glycol, or low-molecular-weight ester alcohols, for example neopentyl glycol hydroxypivalate.

Suitable polyols for producing the polyaddition compounds A2) also include the customary polymeric polyether polyols, polyester polyols, polycarbonate polyols, and/or polyacrylate polyols known from polyurethane chemistry, which typically have a number-average molecular weight of 200 to 22 000, preferably of 250 to 18 000, particularly preferably of 250 to 12 000. A broad overview of suitable polymeric polyols for producing the polyaddition compounds A2) may be found for example in N. Adam et al. Polyurethanes. In: Ullmann's Encyclopedia of Industrial Chemistry, Wiley-VCH Verlag GmbH & Co. KgaA; 2005. URL: https://doi.org/10.1002/14356007.a21_665.pub2. Suitable polyether polyols are for example those of the type recited in DE 26 22 951 B, column 6, line 65 to column 7, line 26, EP-A 0 978 523, page 4, line 45 to page 5, line 14, or WO 2011/069966, page 4, line 20 to page 5, line 23, provided that they conform to the foregoing in respect of functionality and molecular weight. Particularly preferred polyether polyols are addition products of ethylene oxide and/or propylene oxide onto propane-1,2-diol, propane-1,3-diol, glycerol, trimethylolpropane, ethylenediamine and/or pentaerythritol or the polytetramethylene ether glycols having number-average molecular weights of 400 g/mol to 4000 g/mol obtainable by polymerization of tetrahydrofuran according to Angew. Chem. 72, 927 (1960) (https://doi.org/10.1002/ange.19600722402) for example.

Suitable polyester polyols include for example those of the type specified in EP-A 0 978 523, page 5, lines 17 to 47, or EP-A 0 659 792, page 6, lines 32 to 45, provided that they conform to the foregoing in respect of functionality and molecular weight. Particularly preferred polyester polyols are condensation products of polyhydric alcohols, for example ethane-1,2-diol, propane-1,2-diol, diethylene glycol, butane-1,4-diol, hexane-1,6-diol, neopentyl glycol, cyclohexane-1,4-dimethanol, cyclohexane-1,4-diol, perhydrobisphenol, 1,1,1-trimethylolpropane, propane-1,2,3-triol, pentaerythritol and/or sorbitol, with substoichiometric amounts of polybasic carboxylic acids or carboxylic anhydrides, for example succinic acid, adipic acid, sebacic acid, dodecanedioic acid, glutaric anhydride, maleic anhydride, phthalic anhydride, isophthalic acid, terephthalic acid, trimellitic acid, hexahydrophthalic anhydride and/or tetrahydrophthalic anhydride, or those as obtainable in a manner known per se from lactones, for example c-caprolactone, and simple polyhydric alcohols, for example those mentioned above by way of example, as starter molecules with ring opening.

Suitable polycarbonate polyols include in particular the known-per-se reaction products of dihydric alcohols, for example those recited by way of example hereinabove in the list of the polyhydric alcohols, with diaryl carbonates, for example diphenyl carbonate, dimethyl carbonate or phosgene. Suitable polycarbonate polyols likewise include those that contain not only carbonate structures but also ester groups. These are, in particular, the polyestercarbonate diols, known per se, of the kind obtainable, for example, according to the teaching of DE-B 1 770 245 by reaction of dihydric alcohols with lactones, such as in particular c-caprolactone, and subsequent reaction of the resulting polyester diols with diphenyl or dimethyl carbonate.

Suitable polyacrylate polyols include for example those of the type specified in WO 2011/124710 page 10, line 32 to page 13, line 18 provided that they meet the specifications made above in terms of functionality and molecular weight. Particularly preferred polyacrylate polyols include polymers/copolymers of hydroxyalkyl esters of acrylic acid or methacrylic acid, for example hydroxyethyl (meth)acrylate, hydroxypropyl (meth)acrylate or hydroxybutyl (meth)acrylate, optionally together with acrylic acid alkyl esters and/or methacrylic acid alkyl esters, for example methyl (meth)acrylate, ethyl (meth)acrylate, n-butyl (meth)acrylate, iso-butyl (meth)acrylate, 2-ethylhexyl (meth)acrylate, cyclohexyl (meth)acrylate, isobornyl (meth)acrylate, lauryl (meth)acrylate, styrene or other copolymerizable olefinically unsaturated monomers, for example acrylic acid, methacrylic acid or dimethyl maleate.

Suitable polyols also include for example the known polyacetal polyols obtainable by reaction of simple glycols, for example diethylene glycol, triethylene glycol, 4,4′-dioxyethoxydiphenyldimethylmethane (adduct of 2 mol of ethylene oxide onto bisphenol A) or hexanediol, with formaldehyde or else polyacetals prepared by polycondensation of cyclic acetals, for example trioxane.

Suitable polyols for producing the polyaddition compounds A2) further include those described for example in EP-A 0 689 556 and EP-A 0 937 110, for example special polyols obtainable by reaction of epoxidized fatty acid esters with aliphatic or aromatic polyols to bring about epoxide ring opening as well as hydroxyl-containing polybutadienes.

Suitable amines for producing the polyaddition compounds A2) include for example simple aliphatic and cycloaliphatic monoamines, for example methylamine, ethylamine, n-propylamine, isopropylamine, the isomeric butylamines, pentylamines, hexylamines, and octylamines, n-dodecylamine, n-tetradecylamine, n-hexadecylamine, n-octadecylamine, cyclohexylamine, the isomeric methylcyclohexylamines and also aminomethylcyclohexane, secondary monoamines such as dimethylamine, diethylamine, dipropylamine, diisopropylamine, dibutylamine, diisobutylamine, bis(2-ethylhexyl)amine, N-methyl- and N-ethylcyclohexylamine and also dicyclohexylamine.

Suitable amines also include any desired aliphatic and cycloaliphatic amines having at least two primary and/or secondary amino groups, for example 1,2-diaminoethane, 1,2-diaminopropane, 1,3-diaminopropane, 1,4-diaminobutane, 1,2-diamino-2-methylpropane, 1,5-diaminopentane, 1,3-diamino-2,2-dimethylpropane, 1,6-diaminohexane, 1,5-diamino-2-methylpentane, 1,6-diamino-2,2,4-trimethylhexane, 1,6-diamino-2,4,4-trimethylhexane, 1,7-diaminoheptane, 1,8-diaminooctane, 2,5-diamino-2,5-dimethylhexane, 1,9-diaminononane, 2-methyl-1,8-diaminooctane, 1,10-diaminodecane, 1,11-diaminoundecane, 1,12-diaminododecane, 1,2-diaminocyclopentane, 1,2-diaminocyclohexane, 1-amino-3,3,5-trimethyl-5-aminomethylcyclohexane (isophoronediamine, IPDA), 3(4)-aminomethyl-1-methylcyclohexylamine, 1,3-diamino-2- and/or -4-methylcyclohexane, isopropyl-2,4- and/or 2,6-diaminocyclohexane, 1,3-bis(aminomethyl)cyclohexane, 1,8-p-diaminomethane, bis(4-aminocyclohexyl)methane, bis(4-amino-3-methylcyclohexyl)methane, bis(4-amino-3,5-dimethylcyclohexyl)methane, bis(4-amino-2,3,5-trimethylcyclohexyl)methane, 1,1-bis(4-aminocyclohexyl)propane, 2,2-bis(4-aminocyclohexyl)propane, 1 ,1-bis(4-aminocyclohexyl)ethane, 1,1-bis(4-aminocyclohexyl)butane, 2,2-bis(4-aminocyclohexyl)butane, 1,1-bis(4-amino-3-methylcyclohexyl)ethane, 2,2-bis(4-amino-3-methylcyclohexyl)propane, 1,1-bis(4-amino-3,5-dimethylcyclohexyl)ethane, 2,2-bis(4-amino-3,5-dimethylcyclohexyl)propane, 2,2-bis(4-amino-3,5-dimethylcyclohexyl)butane, 2,4-diaminodicyclohexylmethane, 4-aminocyclohexyl-4-amino-3-methylcyclohexylmethane, 4-amino-3,5-dimethylcyclohexyl-4-amino-3-methylcyclohexylmethane, and 2-(4-amino-cyclohexyl)-2-(4-amino-3-methylcyclohexyl)methane, m-xylylenediamine, methyliminobispropylamine, iminobispropylamine, bis(6-aminohexyl)amine, N,N-bis(3-aminopropyl)ethylenediamine, 4-aminomethyl-1,8-octanediamine, bis(aminopropyl)piperazine, aminoethylpiperazine, diethylenetriamine, dipropylenetriamine, triethylenetetramine, tetraethylenepentamine, pentaethylenehexamine, heptaethyleneoctamine.

Suitable amines further include amino-functional polyalkylene glycols, for example 1,2-bis(aminoethoxy)ethane, 1,11-diamino-3,6,9-trioxaundecane, 1,13-diamino-4,7,10-trioxatridecane and in particular the amine-functionalized polyalkylene glycols having number-average molecular weights up to 5000, preferably up to 2000, particularly preferably up to 1000, marketed by Huntsman Corp. under the trade name Jeffamine®.

Optionally also employable for producing the polyaddition compounds A2) are sterically hindered aliphatic diamines having two secondary amino groups, for example the reaction products of aliphatic and/or cycloaliphatic diamines with maleic or fumaric esters disclosed in EP-A 0 403 921, the bisadduct of acrylonitrile with isophoronediamine obtainable according to the teaching of EP-A 1 767 559 or the hydrogenation products of Schiff bases obtainable from aliphatic and/or cycloaliphatic diamines and ketones, for example diisopropyl ketone, described in DE-A 19 701 835 for example.

Suitable polyamines further include the polyamidoamines, polyimines and/or polyvinylamines known as crosslinker components for epoxy resins.

Finally also suitable for producing the polyaddition compounds A2) are amino alcohols, for example 2-aminoethanol, the isomeric aminopropanols and aminobutanols, 3-aminopropane-1,2-diol and 1,3-diamino-2-propanol.

Production of the polyaddition compounds A2) from the isocyanate-functional uretdione-containing compounds A1) employs the recited alcohols and/or amines either individually or as mixtures of at least two such alcohols and/or amines.

Production of the uretdione-containing polyaddition compound A2) may be carried out by various methods, for example the literature processes for producing polyuretdione compositions such as are described for example in WO 99/11690 and WO 2011/115669.

Optionally also co-usable in addition to the isocyanate-functional uretdione-containing compounds A1) are further monomeric isocyanates of the abovementioned type and/or oligomeric polyisocyanates, preferably those having an isocyanurate, biuret, iminooxadiazinedione, allophanate and/or urethane structure, in an amount of up to 30% by weight based on the total weight of all reaction partners (comprising the isocyanate-functional uretdione-containing compounds A1), alcohols and/or amines).

The reaction is preferably carried out while maintaining an equivalent ratio of isocyanate groups to isocyanurate-reactive groups of 2:1 to 0.5:1, preferably of 1.5:1 to 0.7:1, particularly preferably of 1:1 to 0.9:1.

In a further preferred embodiment the polyaddition compounds A2) are compounds obtained by reaction of isocyanate-functional, uretdione-containing compounds A1) with at least difunctional polyols in the molecular weight range 62 to 22 000 and optionally monoalcohols while maintaining an equivalent ratio of isocyanate groups to isocyanate-reactive groups of 2:1 to 0.5:1.

The reaction may be performed solventlessly or in a suitable solvent inert towards isocyanate groups.

Suitable solvents for producing the polyaddition compounds A2) especially include those inert towards the isocyanate groups of the compound A1), for example the known customary aprotic coatings solvents, for example ethyl acetate, isopropyl acetate, butyl acetate, isobutyl acetate, amyl acetate, 2-ethylhexyl acetate, ethylene glycol monomethyl ether acetate, ethylene glycol monoethyl ether acetate, ethylene glycol monobutyl ether acetate, 1-methoxyprop-2-yl acetate, 3-methoxy-n-butyl acetate, acetone, diethyl ketone, 2-butanone, 4-methyl-2-pentanone, diisobutyl ketone, cyclohexanone, cyclohexane, toluene, xylene, chlorobenzene, dichlorobenzene, petroleum spirit, aromatics having a relatively high degree of substitution, as commercially available, for example, under the Solventnaphtha, Solvesso®, Isopar®, Nappar® (Deutsche EXXON CHEMICAL GmbH, Cologne, DE) and ShelIsol® (Deutsche Shell Chemie GmbH, Eschborn, DE) names, but also solvents such as propylene glycol diacetate, diethylene glycol dimethyl ether, dipropylene glycol dimethyl ether, diethylene glycol ethyl and butyl ether acetate, ethyl ethoxypropionate, propylene carbonate, N-methylpyrrolidone and N-methylcaprolactam, dioxane, tetrahydrofuran or any desired mixtures of such solvents.

The reaction of the isocyanate-functional uretdione-containing compounds A1) with the alcohols and/or amines to afford the uretdione-containing polyaddition compounds A2) may be carried out uncatalyzed. However, for the purposes of reaction acceleration it is also possible to employ customary catalysts known from polyurethane chemistry. By way of example mention may be made here of tertiary amines, for example triethylamine, tributylamine, dimethylbenzylamine, diethylbenzylamine, pyridine, methylpyridine, dicyclohexylmethylamine, dimethylcyclohexylamine, N,N,N′,N′-tetramethyldiaminodiethyl ether, bis(dimethylaminopropyl)urea, N-methyl- or N-ethylmorpholine, N-cocomorpholine, N-cyclohexylmorpholine, N,N,N′,N′-tetramethylethylenediamine, N,N,N′,N′-tetramethyl-1,3-butanediamine, N,N,N′,N′-tetramethyl-1,6-hexanediamine, pentamethyldiethylenetriamine, N-methylpiperidine, N-dimethylaminoethylpiperidine, N,N′-dimethylpiperazine, N-methyl-N′-dimethylaminopiperazine, 1,8-diazabicyclo(5.4.0)undec-7-ene, 1,2-dimethylimidazole, 2-methylimidazole, N,N-dimethylimidazole-p-phenylethylamine, 1,4-diazabicyclo-(2,2,2)-octane, bis(N,N-dimethylaminoethyl) adipate; alkanolamine compounds, for example triethanolamine, triisopropanolamine, N-methyl- and N-ethyldiethanolamine, dimethylaminoethanol, 2-(N,N-dimethylaminoethoxy)ethanol, N,N′,N″-tris(dialkylaminoalkyl)hexahydrotriazines, for example N,N′,N″-tris(dimethylaminopropyl)-s-hexahydrotriazine and/or bis(dimethylaminoethyl) ether; metal salts, for example inorganic and/or organic compounds of iron, lead, bismuth, zinc and/or tin in customary oxidation states of the metal, for example iron(II) chloride, iron(III) chloride, bismuth(III) acetate, bismuth(III) 2-ethylhexanoate, bismuth(III) octoate, bismuth(III) neodecanoate, zinc chloride, zinc 2-ethylcaproate, tin(II) octoate, tin(II) ethylcaproate, tin(II) palmitate, dibutyltin(IV) dilaurate (DBTL), dibutydilauryltin mercaptide or lead octoate, amidines, for example 2,3-dimethyl-3,4,5,6-tetrahydropyrimidine; tetraalkylammonium hydroxides, for example tetramethylammonium hydroxide; alkali metal hydroxides, for example sodium hydroxide, alkali metal alkoxides, for example sodium methoxide and potassium isopropoxide, and alkali metal salts of long-chain fatty acids having 10 to 20 carbon atoms and optionally pendant OH groups.

Preferred catalysts are tertiary amines, bismuth and tin compounds of the abovementioned type.

Independently of their mode of production the uretdione-containing polyaddition compounds A2) in solvent-free form in the process according to the invention have a content of free isocyanate groups of less than 5% by weight, preferably of less than 2% by weight and particularly preferably of less than 1% by weight. Isocyanate-free polyaddition compounds A2) are very particularly preferred.

In the process according to the invention the uretdione-containing component A) is combined with a component B) containing at least one hydroxyl and/or at least one thiol group as a reaction partner.

Component B) is for example selected from the compounds recited as suitable alcohols hereinabove for the production of the polyaddition compound A2), in particular at least difunctional polyols of the molecular weight range 62 to 22 000.

Suitable hydroxy-functional components B) are preferably the abovementioned simple polyhydric alcohols having 2 to 14 carbon atoms, low molecular weight ether and ester alcohols and the customary polymeric polyether polyols, polyester polyols, polycarbonate polyols and/or polyacrylate polyols known from polyurethane chemistry.

Suitable components B) are also compounds having at least one thiol group per molecule.

Suitable thiol-functional components B) are preferably polythiols, for example simple alkanethiols, for example methanedithiol, ethane-1,2-dithiol, propane-1,1-dithiol, propane-1,2-dithiol, propane-1,3-dithiol, propane-2,2-dithiol, butane-1,4-dithiol, butane-2,3-dithiol, pentane-1,5-dithiol, hexane-1,6-dithiol, propane-1,2,3-trithiol, cyclohexane-1,1-dithiol, cyclohexane-1,2-dithiol, 2,2-dimethylpropane-1,3-dithiol, 3,4-dimethoxybutane-1,2-dithiol or 2-methylcyclohexane-2,3-dithiol, thioether group-containing polythiols, for example 2,4-dimercaptomethyl-1,5-dimercapto-3-thiapentane, 4-mercaptomethyl-1,8-dimercapto-3,6-dithiaoctane, 4,8-dimercaptomethyl-1,11-dimercapto-3,6,9-trithiaundecane, 4,7-dimercaptomethyl-1,11-dimercapto-3,6,9-trithiaundecane, 5,7-dimercaptomethyl-1,11-dimercapto-3,6,9-trithiaundecane, 5,6-bis(mercaptoethylthio)-1,10-dimercapto-3,8-dithiadecane, 4,5-bis(mercaptoethylthio)-1,10-dimercapto-3,8-dithiadecane, tetrakis(mercaptomethyl)methane, 1,1,3,3-tetrakis(mercaptomethylthio)propane, 1,1,5,5-tetrakis(mercaptomethylthio)-3-thiapentane, 1,1,6,6-tetrakis(mercaptomethylthio)-3,4-dithiahexane, 2-mercaptoethylthio-1,3-dimercaptopropane, 2,3-bis(mercaptoethylthio)-1-mercaptopropane, 2,2-bis(mercaptomethyl)-1,3-dimercaptopropane, bis(mercaptomethyl) sulfide, bis(mercaptomethyl) disulfide, bis(mercaptoethyl) sulfide, bis(mercaptoethyl) disulfide, bis(mercaptopropyl) sulfide, bis(mercaptopropyl) disulfide, bis(mercaptomethylthio)methane, tris(mercaptomethylthio)methane, bis(mercaptoethylthio)methane, tris(mercaptoethylthio)methane, bis(mercaptopropylthio)methane, 1,2-bis(mercaptomethylthio)ethane, 1,2-bis(mercaptoethylthio)ethane, 2-(mercaptoethylthio)ethane, 1,3-bis(mercaptomethylthio)propane, 1,3-bis(mercaptopropylthio)propane, 1,2,3-tris(mercaptomethylthio)propane, 1,2,3-tris(mercaptoethylthio)propane, 1,2,3-tris(mercaptopropylthio)propane, tetrakis(mercaptomethylthio)methane, tetrakis(mercaptoethylthiomethyl)methane, tetrakis(mercaptopropylthiomethyl)methane, 2,5-dimercapto-1,4-dithiane, 2,5-bis(mercaptomethyl)-1,4-dithiane and its oligomers obtainable according to JP-A 07118263, 1,5-bis(mercaptopropyl)-1,4-dithiane, 1,5-bis(2-mercaptoethylthiomethyl)-1,4-dithiane, 2-mercaptomethyl-6-mercapto-1,4-dithiacycloheptane, 2,4,6-trimercapto-1,3,5-trithiane, 2,4,6-trimercaptomethyl-1,3,5-trithiane or 2-(3-bis(mercaptomethyl)-2-thiapropyl)-1,3-dithiolane, polyesterthiols, for example ethylene glycol bis(2-mercaptoacetate), ethylene glycol bis(3-mercaptopropionate), diethylene glycol 2-mercaptoacetate, diethylene glycol 3-mercaptopropionate, 2,3-dimercapto-1-propanol 3-mercaptopropionate, 3-mercaptopropane-1,2-diol bis(2-mercaptoacetate), 3-mercaptopropane-1,2-diol bis(3-mercaptopropionate), trimethylolpropane tris(2-mercaptoacetate), trimethylolpropane tris(3-mercaptopropionate), trimethylolethane tris(2-mercaptoacetate), trimethylolethane tris(3-mercaptopropionate), pentaerythritol tetrakis(2-mercaptoacetate), pentaerythritol tetrakis(3-mercaptopropionate), glycerol tris(2-mercaptoacetate), glycerol tris(3-mercaptopropionate), cyclohexane-1,4-diol bis(2-mercaptoacetate), cyclohexane-1,4-diol bis(3-mercaptopropionate), hydroxymethyl sulfide bis(2-mercaptoacetate), hydroxymethyl sulfide bis(3-mercaptopropionate), hydroxyethyl sulfide 2-mercaptoacetate, hydroxyethyl sulfide 3-mercaptopropionate, hydroxymethyl disulfide 2-mercaptoacetate, hydroxymethyl disulfide 3-mercaptopropionate, (2-mercaptoethyl ester) thioglycolate or bis(2-mercaptoethyl ester) thiodipropionate and aromatic thio compounds, for example 1,2-dimercaptobenzene, 1,3-dimercaptobenzene, 1,4-dimercaptobenzene, 1,2-bis(mercaptomethyl)benzene, 1,4-bis(mercaptomethyl)benzene, 1,2-bis(mercaptoethyl)benzene, 1,4-bis(mercaptoethyl)benzene, 1,2,3-trimercaptobenzene, 1,2,4-trimercaptobenzene, 1,3,5-trimercaptobenzene, 1,2,3-tris(mercaptomethyl)benzene, 1,2,4-tris(mercaptomethyl)benzene, 1,3,5-tris(mercaptomethyl)benzene, 1,2,3-tris(mercaptoethyl)benzene, 1,3,5-tris(mercaptoethyl)benzene, 1,2,4-tris(mercaptoethyl)benzene, toluene-2,5-dithiol, toluene-3,4-dithiol, naphthalene-1,4-dithiol, naphthalene-1,5-dithiol, naphthalene-2,6-dithiol, naphthalene-2,7-dithiol, 1,2,3,4-tetramercaptobenzene, 1,2,3,5-tetramercaptobenzene, 1,2,4,5-tetramercaptobenzene, 1,2,3,4-tetrakis(mercaptomethyl)benzene, 1,2,3,5-tetrakis(mercaptomethyl)benzene, 1,2,4,5-tetrakis(mercaptomethyl)benzene, 1,2,3,4-tetrakis(mercaptoethyl)benzene, 1,2,3,5-tetrakis(mercaptoethyl)benzene, 1,2,4,5-tetrakis(mercaptoethyl)benzene, 2,2′-dimercaptobiphenyl or 4,4′-dimercaptobiphenyl.

Particularly preferred thiol-functional components B) are polyether and polyester thiols of the recited type. Very particularly preferred are 4-mercaptomethyl-1,8-dimercapto-3,6-dithiaoctane, 1,1,3,3-tetrakis(mercaptomethylthio)propane, 5,7-dimercaptomethyl-1,11-dimercapto-3,6,9-trithiaundecane, 4,7-dimercaptomethyl-1,11-dimercapto-3,6,9-trithiaundecane, 4,8-dimercaptomethyl-1,11-dimercapto-3,6,9-trithiaundecane, trimethylolpropane tris(2-mercaptoacetate), trimethylolpropane tris(3-mercaptopropionate), pentaerythritol tetrakis(2-mercaptoacetate) and pentaerythritol tetrakis(3-mercaptopropionate).

Suitable components B) finally also include mercaptoalcohols, for example 2-mercaptoethanol, 3-mercaptopropanol, 1,3-dimercapto-2-propanol, 2,3-dimercaptopropanol or dithioerythritol.

In a further preferred embodiment of the process according to the invention the at least one component A) comprising at least one uretdione group and the at least one component B) comprising at least one hydroxyl and/or at least one thiol group are employed in amounts such that for each uretdione group of component A) there are 0.5 to 2.0, preferably 0.7 to 1.5, particularly preferably 0.8 to 1.2, very particularly preferably precisely one, hydroxyl and/or thiol group(s) of component B).

To accelerate the reaction between the uretdione groups of component A) and the hydroxyl and/or thiol groups of component B) the process according to the invention employs at least one salt-type catalyst C) having an imidazolium and/or imidazolinium cation.

Compounds suitable as catalysts C) are known as imidazolium- and imidazolinium-type ionic liquids and are employed for example as solvents in chemical synthesis. Processes for their production are described for example in Chem. Rev. 99, 8, 2071-2084 and WO 2005/070896.

The catalysts C) are salt-type compounds containing a structural element of general formulae (I) or (II)

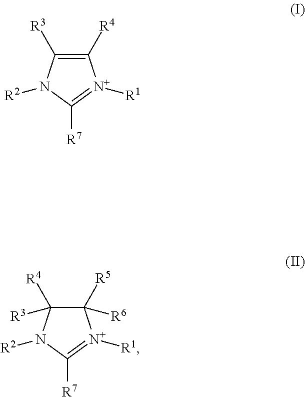

in which
R¹, R², R³, R⁴, R⁵ and R⁶ independently of one another stand for identical or different radicals which represent saturated or unsaturated, linear or branched, aliphatic, cycloaliphatic, araliphatic or aromatic organic radicals having 1 to 18 carbon atoms, which are substituted or unsubstituted and/or have heteroatoms in the chain, wherein the radicals may also in combination with one another and optionally with a further heteroatom form rings having 3 to 8 carbon atoms which may optionally be further substituted,
R³, R⁴, R⁵ and R⁶ may independently of one another also represent hydrogen and
R⁷ represents hydrogen ora carboxylate anion (COO⁻).

Preferred catalysts C) are salt-type compounds containing a structural element of general formulae (I) or (II), in which
R¹ and R² independently of one another stand for identical or different radicals which represent saturated or unsaturated, linear or branched, aliphatic, cycloaliphatic, araliphatic or aromatic organic radicals which have 1 to 12 carbon atoms, are substituted or unsubstituted and/or have heteroatoms in the chain,
R³, R⁴, R⁵ and R⁶ represent hydrogen and wherein
R⁷ represents hydrogen or a carboxylate anion (COO⁻).

Particularly preferred catalysts C) are salt-type compounds containing a structural element of general formulae (I) or (II), in which
R¹ and R² independently of one another stand for identical or different radicals which represent saturated or unsaturated, linear or branched, aliphatic organic radicals having 1 to 12 carbon atoms,
R³, R⁴, R⁵ and R⁶ represent hydrogen and
R⁷ represents hydrogen or a carboxylate anion (COO⁻).

Suitable catalysts of general formula (I) include for example those containing a cation selected from 1,3-dimethylimidazolium, 1-methyl-3-ethylimidazolium, 1-methyl-3-propylimidazolium, 1-methyl-3-butylimidazolium, 1-methyl-3-pentylimidazolium, 1-methyl-3-hexylimidazolium, 1-methyl-3-octylimidazolium, 1-methyl-3-nonylimidazolium, 1-methyl-3-decylimidazolium, 1-decyl-3-methylimidazolium, 1-methyl-3-benzylimidazolium, 1-methyl-3-(3-phenylpropyl)imidazolium, 1-ethyl-3-methylimidazolium (EMIM), 1-isopropyl-3-methylimidazolium, 1-butyl-3-methylimidazolium (BMIM), 1-hexyl-3-methylimidazolium, 1-heptyl-3-methylimidazolium, 1-(2-ethyl)hexyl-3-methylimidazolium (OMIM), 1,3-bis(tert-butyl)imidazolium, 1,3-bis(2,4,6-trimethylphenyl)imidazolium or 1,3-dimethylbenzimidazolium.

Suitable catalysts of general formula (II) include for example those containing a cation selected from 1,3-dimethylimidazolinium, 1-ethyl-3-methylimidazolinium, 1-butyl-3-methylimidazolium, 1,3-bis(2,6-diisopropylphenyl)imidazolinium or 1,3-bis(2,4,6-trimethylphenyl)imidazolinium-1-(1-adamantyl)-3-(2,4,6-trimethylphenyl)imidazolinium,1,3-diphenyl-4,4,5,5-tetramethylimidazolinium, 1,3-di-o-tolyl-4,4,5,5-tetramethylimidazolinium.

As a counterion to the imidazolium and imidazolinium cations the catalysts C) present in the compositions according to the invention contain any inorganic and/or organic anions such as for example halide, sulfate, hydroxysulfate, sulfite, nitrate, carbonate, hydrogencarbonate, arylsulfonate, alkylsulfonate, trifluoromethylsulfonate, alkylsulfate, phosphate, dialkylphosphate, hexafluorophosphate, trifluoromethylborate, tetrafluoroborate, bis(trifluoromethylsulfonyl)imide, dicyanamide and/or carboxylate anions.

The counterion to the imidazolium and imidazolinium cations may in addition also be a carboxylate group (COO⁻) bonded directly to the imidazolium cation as R⁷ of general formula (I), wherein the catalyst C) is in this case in the form of a zwitterionic structure.

Suitable catalysts C) for the compositions according to the invention include for example 1,3-dimethylimidazolium chloride, 1,3-dimethylimidazolium 2-carboxylate, 1,3-dimethylimidazolium dimethylphosphate, 1-ethyl-3-methylimidazolium chloride, 1-ethyl-3-methylimidazolium bromide, 1-ethyl-3-methylimidazolium iodide, 1-ethyl-3-methylimidazolium nitrate, 1-ethyl-3-methylimidazolium hydrogencarbonate, 1-ethyl-3-methylimidazolium methanesulfonate, 1-ethyl-3-methylimidazolium trifluoromethanesulfonate, 1-ethyl-3-methylimidazolium trifluoro(trifluoromethyl)borate, 1-ethyl-3-methylimidazolium hydrogensulfate, 1-ethyl-3-methylimidazolium ethylsulfate, 1-ethyl-3-methylimidazolium dicyanamide, 1-ethyl-3-methylimidazolium tetrafluoroborate, 1-ethyl-3-methylimidazolium diethylphosphate, 1-ethyl-3-methylimidazolium hexafluorophosphate, 1-ethyl-3-methylimidazolium bis(trifluoromethanesulfonyl)imide, 1-ethyl-3-methylimidazolium 2-carboxylate, 1-ethyl-3-methylimidazolium acetate, 1-ethyl-3-methylimidazolium (L)-(+)-lactate, 1-methyl-3-propylimidazolium iodide, 1,3-diisopropyl-4,5-dimethylimidazolium 2-carboxylate, 1-butyl-3-methylimidazolium chloride, 1-butyl-3-methylimidazolium bromide, 1-butyl-3-methylimidazolium iodide, 1-butyl-3-methylimidazolium trifluoromethanesulfonate, 1-butyl-3-methylimidazolium ethylsulfate, 1-butyl-3-methylimidazolium n-octylsulfate, 1-butyl-3-methylimidazolium dicyanamide, 1-butyl-3-methylimidazolium trifluoro(trifluoromethyl)borate, 1-butyl-3-methylimidazolium tetrafluoroborate, 1-butyl-3-methylimidazolium dibutylphosphate, 1-butyl-3-methylimidazolium hexafluorophosphate, 1-butyl-3-methylimidazolium 2-carboxylate, 1-butyl-3-methylimidazolium acetate, 1-butyl-3-methylimidazolium bis(trifluoromethanesulfonyl)imide, bis(tert-butyl)imidazolium 2-carboxylate, 1-hexyl-3-methylimidazolium chloride, 1-hexyl-3-methylimidazolium bromide, 1-hexyl-3-methylimidazolium tetrafluoroborate, 1-hexyl-3-methylimidazolium bis(trifluoromethanesulfonyl)imide, 1-hexyl-3-methylimidazolium hexafluorophosphate, 1-methyl-3-n-octylimidazolium bromide, 1-methyl-3-n-octylimidazolium chloride, 1-methyl-3-n-octylimidazolium hexafluorophosphate, 1-decyl-3-methylimidazolium bis(trifluoromethansulfonyl)imide, 1,3-dimethylimidazolinium chloride, 1,3-dimethylimidazolinium 2-carboxylate, 1,3-dimethylimidazolinium acetate, 1-ethyl-3-methylimidazolinium chloride, 1-ethyl-3-methylimidazolinium 2-carboxylate, 1-ethyl-3-methylimidazolinium acetate, 1-butyl-3-methylimidazolinium 2-carboxylate, 1,3-bis(2,6-diisopropylphenyl)imidazoliniumchloride or 1,3-bis(2,4,6-trimethylphenyhimidazolinium-1-(1-adamantyl)-3-(2,4,6-trimethylphenyhimidazolinium chloride and/or 1,3-diphenyl-4,4,5,5-tetramethylimidazolinium chloride.

Particularly preferred catalysts C) are imidazolium salts of the recited type with carboxylate anions, very particularly preferably 1,3-dimethylimidazolium 2-carboxylate, 1-ethyl-3-methylimidazolium 2-carboxylate, 1-ethyl-3-methylimidazolium acetate, 1-butyl-3-methylimidazolium 2-carboxylate and/or 1-butyl-3-methylimidazolium acetate.

In a further preferred embodiment the catalysts C) are employed in the process according to the invention either individually or as mixtures of at least two such catalysts in an amount of 0.001% to 15% by weight, preferably 0.005% to 12% by weight, particularly preferably 0.01% to 10% by weight, based on the total weight of components A) and B), excluding any solvents and auxiliary or additive substances present in these components.

It is also possible to co-use further co-catalytic compounds in the process according to the invention to control the selectivity of the uretdione reaction. These include in particular organic zinc salts, for example zinc(II) stearate, zinc(II) n-octanoate, zinc(II) 2-ethyl-1-hexanoate, zinc(II) naphthenate or zinc(II) acetylacetonate, which are employed, if at all, individually or as mixtures of at least two such co-catalysts in an amount of 0.01 to 100 mol % based on the amount of catalyst C). The preferred co-catalyst is zinc(II) acetylacetonate.

The process according to the invention is exceptionally suitable for producing polyurethane plastics and is used therefor. The process according to the invention is preferably used for producing coating formulations.

The present invention therefore likewise provides compositions, preferably coating formulations, containing either at least one component A) comprising at least one uretdione group, at least one component B) comprising at least one thiol group and at least one catalyst C) having an imidazolium or imidazolinium structure and optionally further auxiliary and additive substances or containing at least one at least one polyaddition compound A2) which in solvent-free form has a content of free isocyanate groups of less than 5% by weight, at least one component B) comprising at least one hydroxyl and/or thiol group and at least one catalyst C) having an imidazolium or imidazolinium structure and optionally further auxiliary and additive substances. The at least one polyaddition compound A2) in solvent-free form preferably has a content of free isocyanate groups of less than 2% by weight, particularly preferably of less than 1% by weight. Isocyanate-free polyaddition compounds A2) are very particularly preferred.

The performance of the process according to the invention and curing of the compositions according to the invention is preferably carried out according to the activity of the employed catalyst generally in the temperature range of 20° C. to 200° C., preferably of 60° C. to 180° C., particularly preferably of 70° C. to 170° C. and very particularly preferably of 80° C. to 160° C., by preference over a period of 1 minute to 12 hours, preferably 10 minutes to 3 hours.

Under these conditions the uretdione groups originally present in component A) generally undergo complete reaction to form allophanate groups and/or thioallophanate groups and optionally isocyanurate groups.

The present invention further provides for the use of at least one composition according to the invention for producing polyurethane plastics. In addition, the present invention further provides for the use of at least one composition according to the invention for producing coating formulations.

Substrates contemplated for the coatings formulated using the compositions according to the invention include any desired substrates, for example, metal, wood, glass, stone, ceramic materials, concrete, rigid and flexible plastics, textiles, leather, and paper, which prior to coating may optionally also be provided with customary primers.

The invention further provides coating compositions containing at least one composition according to the invention and a substrate coated with an optionally heat-cured coating formulation according to the invention.

The coating formulations formulated with the compositions according to the invention which may optionally be admixed with the customary auxiliary and additive substances known to those skilled in the art of coating technology, for example solvents, UV stabilizers, antioxidants, flow control agents, rheological additives, slip additives, dyes, matting agents, flame retardants, hydrolysis inhibitors, microbicides, algicides, water scavengers, thixotropic agents, wetting agents, deaerating agents, adhesion promoters, fillers and/or pigments, afford films having good coatings properties under the recited curing conditions.

The invention likewise provides polyurethane plastics, preferably coatings, obtained by using the above-described coating formulations.

### EXAMPLES

All percentages are based on weight, unless stated otherwise.

NCO contents were determined titrimetrically in accordance with DIN EN ISO 11909:2007-05.

All viscosity measurements were recorded with a Physica MCR 51 rheometer from Anton Paar Germany GmbH (DE) according to DIN EN ISO 3219:1994-10 at a shear rate 5 of 250 s-1.

Residual monomer contents were measured in accordance with DIN EN ISO 10283:2007-11 by gas chromatography with an internal standard.

The compositions of the uretdione model compounds were determined by gel permeation chromatography based on DIN 55672-1:2016-03 (gel permeation chromatography (GPC)—part 1: tetrahydrofuran (THF) as eluent) with the modification that a flow rate of 0.6 ml/min rather than 1.0 ml/min was used. The proportions of the different oligomers from the chromatograms in area % which were determined with software assistance were in each case approximately equated with proportions in % by weight.

König pendulum damping was determined in accordance with DIN EN ISO 1522:2007-04 on glass plates.

The uretdione reaction products formed during curing of the compositions according to the invention were determined using proton-decoupled ¹³C-NMR spectra (recorded using CDCl₃ solvent on a Bruker DPX-400 instrument). The individual structural elements have the following chemical shifts (in ppm): uretdione: 157.1; isocyanurate: 148.4; allophanate: 155.7 and 153.8.

Solvent resistance was determined using xylene as a typical coatings solvent. To this end a small amount of the solvent was added to a test tube and provided with a cotton pad at the opening so that an atmosphere saturated with xylene was formed inside the test tube. The test tube was subsequently placed with the cotton pad on the lacquer surface and remained there for 5 minutes. Once the solvent had been wiped off, the film was examined for destruction/softening/loss of adhesion. (0=no change, 5=film destroyed)

Starting Compounds

Production of an HDI Uretdione Model Compound (HDI-UD1)

### Production of 1,3-bis(6-isocyanatohexyl)-1,3-diazetidine-2,4-dione

According to the process described in example 1 of EP-A 0 789 017, 1,3-bis(6-isocyanatohexyl)-1,3-diazetidine-2,4-dione (ideal bis(6-isocyanatohexyl)uretdione) was produced by tributylphosphine-catalyzed oligomerization of 1,6-diisocyanatohexane (HDI) and subsequent distillative workup.

NCO content: 25.0%

Monomeric HDI: <0.03%

Viscosity (23° C.): 28 mPas

Analysis by gel permeation chromatography (GPC) reveals the following composition:

| | | |
|---|---|---|
| HDI uretdione (n = 2): | 99.2% | (according to GPC) |
| HDI isocyanurate (n = 3): | 0.4% | (according to GPC) |
| higher oligomers: | 0.4% | (according to GPC) |

### Production of the dimethylurethane of bis(6-isocyanatohexyl)uretdione (HDI-UD1)

10 g (0.0595 eq) of the above-described HDI uretdione were dissolved in 30 ml of dichloromethane, admixed with 2 g (0.0625 mol) of methanol and stirred at 40° C. under dry nitrogen until isocyanate was no longer detectable by IR spectroscopy after 8 h. Dichloromethane and excess methanol were then removed using a rotary evaporator. The dimethylurethane of bis(6-isocyanatohexyl)uretdione (HDI-UD1) was obtained as a colorless solid.

Uretdione group content: 21.0% (calculated as C₂N₂O₂, molecular weight 84)

Production of an HDI Polyuretdione Crosslinker (HDI-UD2)

1000 g (5.95 eq) of the above-described ideal bis(6-isocyanatohexyl) uretdione (NCO content: 25.0%) were dissolved in 800 g of butyl acetate, 4.6 g (0.2% by weight) of a 10% solution of dibutyltin dilaurate (DBTL) in butyl acetate were added and the mixture was heated to 80° C. under dry nitrogen and with stirring. A mixture of 347.5 g (4.76 eq) of 2,2,4-trimethylpentane-1,3-diol and 154.7 g (1.19 eq) of 2-ethyl-1-hexanol was added dropwise to this solution over 2 hours. After a stirring time of 16 hours at 80° C. the NCO content was <0.2%. A practically colorless solution of an HDI polyuretdione crosslinker (HDI-UD2) was obtained.

NCO content: 0.16%

Uretdione group content: 10.8% (calculated as C₂N₂O₂, molecular weight 84) Uretdione functionality: 5 (calculated)

Solids content: about 65%

Viscosity (23° C.): 1400 mPas

Production of a PDI Uretdione Model Compound (PDI-UD1)

### Production of 1,3-bis(5-isocyanatopentyI)-1,3-diazetidine-2,4-dione

According to the process described in example 1 of EP-A 0 789 017, 1,3-bis(5-isocyanatopentyl)-1,3-diazetidine-2,4-dione (ideal bis(5-isocyanatopentyl)uretdione) was produced by tributylphosphine-catalyzed oligomerization of 1,5-diisocyanatopentane (PDI) instead of 1,6-diisocyanatohexane (HDI) and subsequent distillative workup.

NCO content: 27.3%

Monomeric PDI: 0.03%

Viscosity (23° C.): 22 mPas

Analysis by gel permeation chromatography (GPC) reveals the following composition:

| | | |
|---|---|---|
| HDI uretdione (n = 2): | 98.7% | (according to GPC) |
| HDI isocyanurate (n = 3): | 0.7% | (according to GPC) |
| higher oligomers: | 0.6% | (according to GPC) |

### Production of the dimethyl urethane of bis(5-isocyanatopentyl)uretdione (PDI-UD1)

10 g (0.065 eq) of the above-described PDI uretdione were dissolved in 30 ml of dichloromethane, admixed with 2 g (0.068 mol) of methanol and stirred at 40° C. under dry nitrogen until isocyanate was no longer detectable by IR spectroscopy after 8 h. Dichloromethane and excess methanol were then removed using a rotary evaporator. The dimethylurethane of bis(5-isocyanatopentyl)uretdione (PDI-UD1) was obtained as a colorless solid. There were no longer any free isocyanate groups detectable by IR spectroscopy (no isocyanate absorption band at 2270 cm⁻¹).

Uretdione group content: 22.3% (calculated as C₂N₂O₂, molecular weight 84)

Catalysts

1-Ethyl-3-methylimidazolium acetate (97%), Sigma-Aldrich Chemie GmbH, Munich, DE

1,3-dimethylimidazolium 2-carbon/late, produced by the process described in J. Org. Chem. 73, 14, 5582-5584

1-Ethyl-3-methylimidazolium 2-carbon/late, produced by the process described in Chem. Eur. J. 2016, 22, 16292-16303

### Example 1

In an oven-dried and pressure-resistant reaction vial 6.8 mg (0.04 mmol) of 1-ethyl-3-methylimidazolium acetate together with 28.2 mg (0.21 mmol) of 2-(2-ethoxyethoxy)ethanol (Carbitol) were dissolved in 1.0 ml of absolute tetrahydrofuran (THF). Then 80.0 mg (0.20 mmol) of the HDI uretdione model compound (HDI-UD1) were added and the contents of the closed reaction vessel were stirred at 80° C. for one hour. After removal of the solvent under high vacuum the ¹³C NMR spectrum of the mixture showed complete conversion of the employed uretdione to allophanate and isocyanurate groups. The molar ratio of allophanate to isocyanurate groups was 90:10.

### Example 2

In an oven-dried and pressure-resistant reaction vial 8.1 mg (0.04 mmol) of 1,3-dimethylimidazolium 2-carbon/late together with 28.2 mg (0.21 mmol) of Carbitol were dissolved in 1.0 ml of absolute THF. Then 80.0 mg (0.20 mmol) of the HDI uretdione model compound (HDI-UD1) were added and the contents of the closed reaction vessel were stirred at 80° C. for one hour. After removal of the solvent under high vacuum the ¹³C NMR spectrum of the mixture showed complete conversion of the employed uretdione to allophanate and isocyanurate groups. The molar ratio of allophanate to isocyanurate groups was 87:13.

### Example 3

In an oven-dried and pressure-resistant reaction vial 6.2 mg (0.04 mmol) of 1-ethyl-3-methylimidazolium 2-carbon/late together with 28.2 mg (0.21 mmol) of Carbitol were dissolved in 1.0 ml of absolute THF. Then 80.0 mg (0.20 mmol) of the HDI uretdione model compound (HDI-UD1) were added and the contents of the closed reaction vessel were stirred at 80° C. for one hour. After removal of the solvent under high vacuum the ¹³C NMR spectrum of the mixture showed complete conversion of the employed uretdione to allophanate and isocyanurate groups. The molar ratio of allophanate to isocyanurate groups was 88:12.

### Example 4

In an oven-dried and pressure-resistant reaction vial 0.05 g (0.3 mmol) of sodium ethyldithiocarbonate together with 0.23 g (1.7 mmol) of Carbitol were dissolved in 12.1 ml of absolute tetrahydrofuran (THF). Then 0.61 g (1.6 mmol) of the PDI uretdione model compound (PDI-UD1) were added and the contents of the closed reaction vessel were stirred at 24° C. for one hour. After removal of the solvent under high vacuum the ¹³C NMR spectrum of the mixture showed complete conversion of the employed uretdione to allophanate and isocyanurate groups. The molar ratio of allophanate to isocyanurate groups was 90:10.

### Example 5

### Inventive and Comparative

100 g (0.559 eq) of a commercially available, aromatics-free branched polyester polyol having a solids content of 75% in butyl acetate and an OH content of 9.5% based on solid resin, obtainable under the name Desmophen 775 XP (Covestro Deutschland AG, Leverkusen, DE), were mixed with 197.6 g (0.254 eq) of the HDI polyuretdione crosslinker (HDI-UD2) corresponding to an equivalent ratio of hydroxyl groups to uretdione groups of 1.1:1 to afford a coating formulation which, after addition of 3.0 g (18.2 mmol, 1.0%) of 1-ethyl-3-methylimidazolium acetate as catalyst, was applied to a degreased glass sheet using a film applicator in an applied film thickness of 150 μm.

For comparison, by the same process 100 g of Desmophen 775 XP and 197.6 g of the HDI polyuretdione crosslinker (HDI-UD2), likewise corresponding to an equivalent ratio of hydroxyl groups to uretdione groups of 1.1:1, were used to produce a coating formulation and after addition of 2.9 g (18.8 mmol, 1.0%) of 1,8-diazabicyclo[5.4.0]undec-7-ene (DBU) as catalyst said formulation was applied to a degreased glass sheet using a film applicator in an applied film thickness of 150 μm.

After flashing off at room temperature for 15 minutes both coatings were cured at 100° C. over 30 min. In both cases, hard, elastic and completely transparent coatings were obtained, which differed as follows:

| | 1-ethyl-3-methylimidazolium | DBU |
|---|---|---|
| Catalyst | acetate (inventive) | (comparative) |
| Visual assessment | good | slight structure |
| Flow color | colorless | yellow |
| Pendulum damping | 103 s | 79 s |
| Xylene resistance | 2 | 5 |

### Example 6

51.4 g (0.421 eq) of pentaerythritol tetrakis(3-mercaptopropionate) (solids content: 100%, SH content: 26%), available under the name THIOCURE PETMP (Bruno Bock Chemische Fabrik GmbH & Co. KG, Marschacht, DE), were mixed with 148.6 g (0.191 eq) of the HDI polyuretdione crosslinker (HDI-UD2) corresponding to an equivalent ratio of thiol groups to uretdione groups of 1.1:1 to afford a coating formulation which, after addition of 2.0 g (12.1 mmol, 1.0%) of 1-ethyl-3-methylimidazolium acetate as catalyst, was applied to a degreased glass sheet using a film applicator in an applied film thickness of 150 μm. After flashing off at room temperature for 15 minutes the coating was cured at 100° C. over 30 min.

A smooth, colorless transparent coating was obtained which had pendulum damping of 160 s and a xylene resistance of 1-2.

1. A process for producing at least one of an allophanate and a thioallophanate-containing compound, the process comprising reacting
A) at least one component comprising at least one uretdione group with
B) at least one component comprising at least one of a hydroxyl group and a thiol group in the presence of
C) at least one catalyst containing a structural element of at least one of formulae (I) and (II) 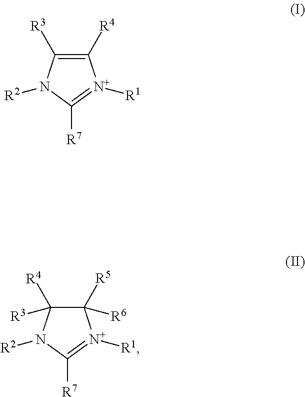
in which
R¹, R², R³, R⁴, R⁵ and R⁶ independently of one another are identical or different radicals which represent saturated or unsaturated, linear or branched, aliphatic, cycloaliphatic, araliphatic or aromatic organic radicals having 1 to 18 carbon atoms which are substituted or unsubstituted and/or have heteroatoms in the chain, wherein the radicals may also in combination with one another and optionally with a further heteroatom form rings having 3 to 8 carbon atoms which may optionally be further substituted, wherein
R³, R⁴, R⁵ and R⁶ may independently of one another also represent hydrogen and
R⁷ represents hydrogen or a carboxylate anion (COO⁻),
wherein the at least one component A) comprising at least one uretdione group is selected from polyaddition compounds A2) obtainable by reaction of isocyanate-functional uretdione-containing compounds A1) with alcohols and/or amines which in solvent-free form have a content of free isocyanate groups of less than 5% by weight.

2. The process as claimed in claim 1, wherein the component A1) is selected from the group consisting of uretdione-containing compounds based on PDI, HDI, IPDI, XDI, NBDI, and H₁₂-MDI which preferably have an average NCO functionality of at least 1.6 and have a content of uretdione structures (calculated as C₂N₂O₂, molecular weight=84) of 10% to 25% by weight.

3. The process as claimed in claim 1, wherein the polyaddition compounds A2) is selected from the group consisting of compounds obtained by reaction of isocyanate-functional, uretdione-containing compounds A1) with at least difunctional polyols in the molecular weight range 62 to 22 000, and optionally monoalcohols while maintaining an equivalent ratio of isocyanate groups to isocyanate-reactive groups of 2:1 to 0.5:1.

4. The process as claimed in claim 2, wherein the uretdione-containing polyaddition compounds A2) in solvent-free form have a content of free isocyanate groups of less than 2% by weight.

5. The process as claimed in claim 1, wherein component B) is selected from at least difunctional polyols in the molecular weight range 62 to 22 000.

6. The process as claimed in claim 1, wherein components A) and B) are employed in amounts such that for each uretdione group of component A) there are 0.5 to 2.0 hydroxyl and/or thiol groups of component B).

7. The process as claimed in claim 1, wherein component C) is selected from catalysts containing a structural element of general formulae (I) and/or (II), in which
R¹ and R² independently of one another stand forare identical or different radicals which represent saturated or unsaturated, linear or branched, aliphatic, cycloaliphatic, araliphatic or aromatic organic radicals which have 1 to 12 carbon atoms, are substituted or unsubstituted and/or have heteroatoms in the chain,
R³, R⁴, R⁵ and R⁶ represent hydrogen and wherein
R⁷ represents hydrogen or a carboxylate anion (COO⁻).

8. The process as claimed in claim 1, wherein component C) is selected from the group consisting of catalysts containing a structural element of general formulae (I) and/or (II), in which
R¹ and R² independently of one another are identical or different radicals which represent saturated or unsaturated, linear or branched, aliphatic organic radicals having 1 to 12 carbon atoms,
R³, R⁴, R⁵ and R⁶ represent hydrogen and
R⁷ represents hydrogen or a carboxylate anion (COO⁻).

9. The process as claimed in claim 1, wherein catalyst C) is selected from the group consisting of imidazolium salts of 1,3-dimethylimidazolium 2-carboxylate, 1-ethyl-3-methylimidazolium 2-carboxylate, 1-ethyl-3-methylimidazolium acetate, 1-butyl-3-methylimidazolium 2-carboxylate, and 1-butyl-3-methylimidazolium acetate.

10. The process as claimed in claim 1, wherein component C) is present in an amount of 0.001% to 15% by weight, based on the total weight of components A) and B), excluding any solvents and auxiliary or additive substances present in these components.

11. A composition containing at least one component A) comprising at least one uretdione group, at least one component B) comprising at least one thiol group and at least one catalyst C) having an imidazolium or imidazolinium structure and optionally further auxiliary and additive substances or containing at least one at least one polyaddition compound A2) which in solvent-free form has a content of free isocyanate groups of less than 5% by weight, at least one component B) comprising at least one hydroxyl and/or thiol group and at least one catalyst C) having an imidazolium or imidazolinium structure and optionally further auxiliary and additive substances.

12. (canceled)

13. A coating formulation containing the compositions as claimed in claim 11.

14. A substrate coated with the coating formulation as claimed in claim 13.

15. A polyurethane plastic obtained from the composition as claimed in claim 11.

16. The process as claimed in claim 2, wherein the uretdione-containing polyaddition compounds A2) in solvent-free form have a content of free isocyanate groups of less than 1% by weight.

17. The process as claimed in claim 2, wherein the uretdione-containing polyaddition compounds A2) in solvent-free form are isocyanate-free.

18. The substrate as claimed in claim 14, wherein the composition is heat-cured.

19. The polyurethane plastic as claimed in claim 15, wherein the composition is heat-cured.
